(19) United States
(12) Patent Application Publication
(10) Pub. No.: US 2006/0232079 A1
(43) Pub. Date: Oct. 19, 2006

(54) Door lock having simple installation process and suitable for passage and bathroom doors

(76) Inventor: Wen-Ching Hsieh, Lujhou City (TW)

Correspondence Address: Wen-Ching Hsieh, P.O. Box No. 6-57, Junghe, Taipei, 235, TW

(21) Appl. No.: 11/108,803

(22) Filed: Apr. 19, 2005

(51) Int. Cl. E05B 3/00

(52) U.S. Cl. 292/336.3

(57) ABSTRACT

A door lock having a simple installation process and suitable for passage and bathroom doors includes a handle, a variant axis, a locating tray, a spring, a locking member, a spring plate and a locating plate. The variant axis is placed into an axis of the locating plate. The spring is pre-placed into a central space of the variant axis. The locking member is installed into the variant axis, followed by wedging in the spring plate and the locating plate. The aforesaid structure simplifies a prior invention having three elements to two elements, thereby providing a simple installation process.

### BACKGROUND OF THE INVENTION

(a) Field of the Invention

The invention relates to a door lock having a simple installation process and suitable for passage and bathroom doors, and more particularly, to a door lock having a simple and practical structure that can be readily and extensively applied to passage and bathroom doors. The invention comprises a variant axis located in an axis opening of a locating tray thereof. A spring is pre-placed into a central space of the variant axis. A locking member is installed into a central hole of the variant axis, followed by fastening a spring plate and a locating plate therein. Using an eccentric structure of the locating plate that is joined with a recess of the locking member, the locking member is retained with a specific operating range. The variant axis is then riveted with the locating plate. The structure according to the invention simplifies a prior invention having three elements to two elements, thereby providing a simple installation process.

(b) Description of the Prior Art

On the market, there are various lock devices such as horn-shaped locks and gate locks. These lock devices effectively increase safety of people's every life.

A convention door lock for passage and bathroom doors generally comprises a lock member, a bounce-back mechanism, and a handle at each two sides thereof. To assemble the lock, the lock member is respectively inserted through inner and outer sections of the bounce-back mechanism, and lock structure is completed by installing the handles and copper housings. To be able to assemble such kind of lock structures, it is necessary that an installation user have professional knowledge regarding installation directions and sides. Hence, requirements including being readily installed by an ordinary user and having common practicability are unmet.

Therefore, it is a vital task of the invention as how to overcome the aforesaid drawbacks of having complex installation process and unsatisfactory practicability as well as not being readily assembled by an ordinary user.

### SUMMARY OF THE INVENTION

In view of the aforesaid drawbacks of the prior invention, the primary object of the invention is to provide a door lock having a simple installation process and suitable for passage and bathroom doors, in that the door lock effectively overcomes drawbacks of complicated installation process, can be readily applied, and has a simple structure as well as enhance practicability. The structure according to the invention has a simple and flexible installation process, and can be installed by an ordinary user, thereby elevating practicability of the door lock.

To accomplish the aforesaid object, a door lock having a simple installation process and suitable for passage and bathroom doors comprise a variant axis inserted through a locating tray to connect the entire structure to a door handle, a spring, a locking member, a spring plate and a locating plate.

The spring is pre-placed into a central space of the variant axis, the locking member is set into the variant axis, and the spring plate and the locating plate are assembled in sequence, followed by riveting the variant axis with the locating plate.

In addition, the locating plate has four openings having eccentric effects, wherein the four openings work in coordination with two corresponding rivet pins of the variant axis. Using a recess at a center section of the locking member, the assembled rivet pins and rivet openings are wedged into the recess to fasten the locking member, so as to retain an operating range of the locking member. The variant axis is then riveted with the locating plate. The above structure according to the invention simplifies a prior invention having two elements into two elements only, and thus providing a simple installation process.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded partial elevational schematic view illustrating the structure according to the invention.

FIG. 2 shows a partial top sectional schematic view illustrating the structure according to the invention.

FIG. 3 shows a top sectional schematic view illustrating and embodiment according to the invention.

### DETAILED DESCRIPTION OF THE PREFERRED EMBODIMENTS

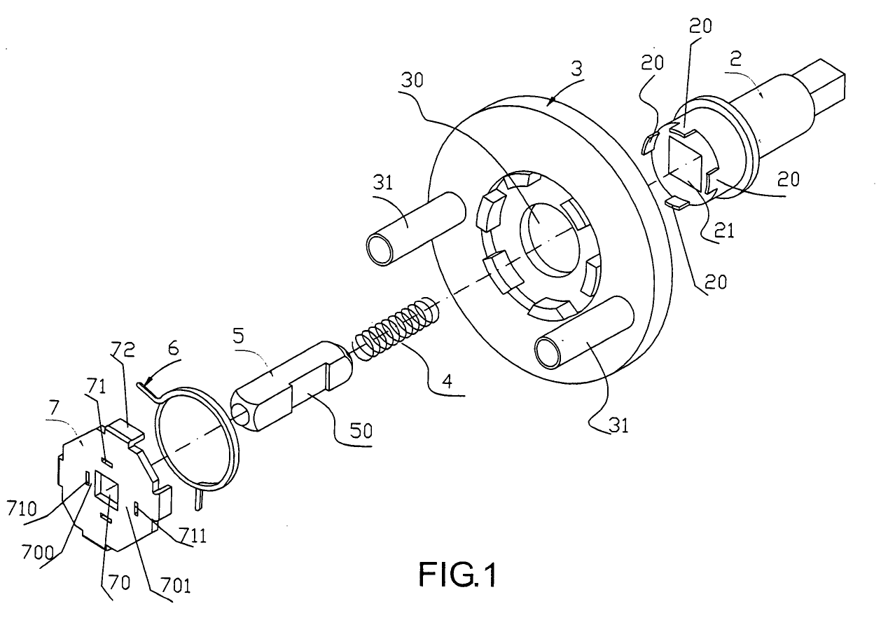

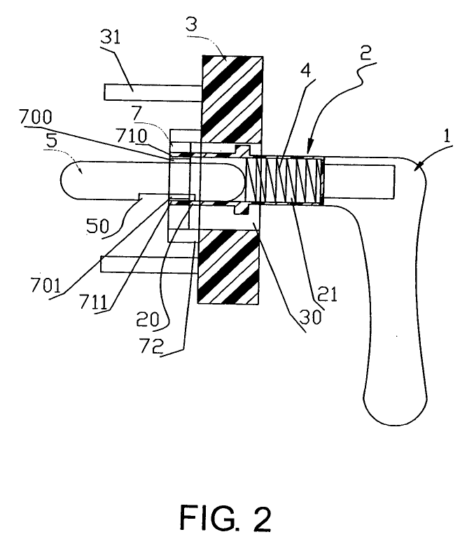

Referring to FIGS. 1 and 2, a door lock having a simple installation process and suitable for passage and bathroom doors comprises:

a handle 1 as a formed integral or an assembly finished by processing, wherein each of inner and outer sections of the handle 1 is capable of independently opening and closing a door;

a variant axis 2, which has one end thereof embedded to the handle 1 and fixed to a locating tray 3 to fasten the structure to the handle, the other end thereof wedged into a rivet opening 71 of a locating plate 7 through variant axis rivet pins 20, and a center thereof provided with a central hole 21 having an accommodating space for insertion;

a locating tray 3 having an axis opening 30 for inserting through the variant axis 2, and screw connecting columns 31 for fastening the locating tray 3 to inner and outer sections of the door in conjunction with screws;

a spring 4 pre-placed into the variant axis central hole 21 to coordinate with contractions and extensions of the locking member 5;

a locking member 5, which has one end thereof placed into the central hole 21 of the variant axis 2, the other end thereof penetrated through the locating plate 7 with the penetrated and exposed section joined with a slanted plate to accomplishing driving and turning effects, and a center section of one side thereof provided with a recess 50 for limiting contractions and extensions of the locking member 5;

a spring 6 plate, which is joined with the lock and driven by turning of the handle 1 for clockwise and counterclockwise turning movements to further interlock a switch structure within the lock, thereby proceeding with opening and closing movements of the door lock; and

a locating plate 7, which has a locating hole 70 for inserting through the lock member 5, wherein, the locating hole 70 of the locating plate 7 has eccentric effects, meaning that four rivet openings 71, 71, 710 and 711 around the locating hole 70 can be connected and fixed with the rivet pins 20; and wedge pins 72 at a periphery thereof for wedging into the locating tray 3 for positioning and producing bounce-back reactions in conjunction with the spring plate 6.

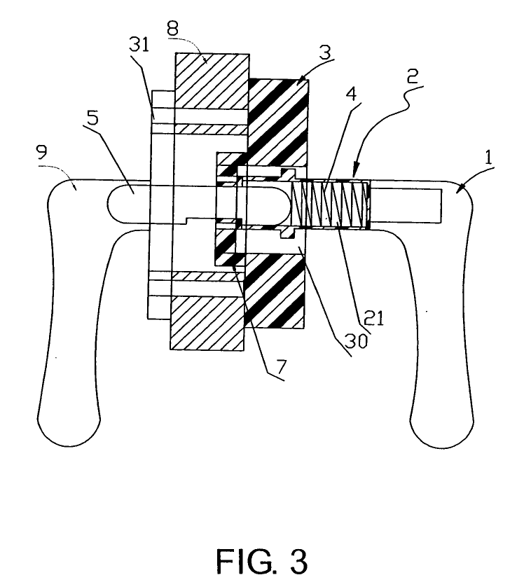

Referring to FIG. 3 along with other drawings, the spring 4 is pre-placed into the central hole 21 of the variant axis 2, the locking member 5 is placed into the variant 2, and the spring plate 6 and the locating plate 7 are wedged and locked therein in sequence. The locating plate 7 is provided with eccentric effects, and hence when the left and right rivet openings 710 and 711 are wedged with corresponding rivet pins 20, the locating hole 70 is fastened with the recess 50 of the locking member 5 to fix the locking member 5, such that the locking member 5 is not bounced out of the variant axis 2. By joining the columns 31 of the locating tray 3 with a door 8, one end of the lock is fixed to the door 8. To assemble the entire structure of the lock, a handle 9 at the other side is installed to complete the installation process. In addition, the variant axis 2 has one end thereof devised with specific combined structure of a round pole and a rectangular pole, and thus the variant axis 2 can be connected to a driving structure of the handles while providing the handles with bounce-back effects. The variant axis 2 also has one end thereof inserted through the locating tray 3, and a center section thereof devised with rectangular and round sealed holes that provide the locking member 5 and the spring 4 with operating spaces.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A door lock having a simple installation process and suitable for passage and bathroom doors, comprising:
a variant axis, which has one end thereof embedded to a handle and fixed to a locating tray to fasten the structure to the handle, the other end thereof wedged into a rivet opening of a locating plate using variant axis rivet pins, and a center section thereof provided with a central hole having an accommodating space for insertion;
a locating tray having a central axis opening for inserting through the variant axis, and screw connecting columns for fastening inner-end elements in conjunction with screws;
a spring pre-placed into the variant axis central hole;
a locking member, which has one end thereof placed into the central hole of the variant axis, the other end thereof penetrated through the locating plate in an exposed manner to be further joined with a lock bolt when assembled, and a recess at a side thereof; and
a locating plate, which facilitates the locking member to insert through, and has four rivet openings at a periphery thereof and a central rectangular hole with eccentric effects.

2. The door lock having a simple installation process and suitable for passage and bathroom doors in accordance with claim 1, wherein, after installing a lock bolt structure, the aforesaid structure is assembled to inner and outer section of a door, fastened using two screws, followed by assembling copper housings, handles and other elements.

3. The door lock having a simple installation process and suitable for passage and bathroom doors in accordance with claim 1, wherein, the central rectangular hole of the locating plate has eccentric effects, left and right rivet openings are wedged with corresponding rivet pins of the variant axis, and the locating plate hole is placed into the recess of the locking member, thereby by prohibiting the locking member from bouncing out of the variant axis and retaining movements of the locking member.

4. The door lock having a simple installation process and suitable for passage and bathroom doors in accordance with claim 1, wherein, the variant axis has one end thereof devised with a specific combined structure of a round pole and a rectangular pole, such that the variant axis is connected to a driving structure of the handles while providing the handles with bounce-back effects; one end thereof inserted through the locating tray; has a center section thereof devised with rectangular and round sealed holes that provide the locking member and the spring with operating spaces,
